(19) United States
(12) Patent Application Publication
(10) Pub. No.: US 2009/0222519 A1
(43) Pub. Date: Sep. 3, 2009

(54) COMPUTER-BASED METHODS FOR ARRANGING MEETINGS AND SYSTEMS FOR PERFORMING THE SAME

(76) Inventor: John Boyd, Ridgefield, CT (US)

Correspondence Address: JOHN BOYD, 9 BEECHWOOD LANE, RIDGEFIELD, CT, 06877, US

(21) Appl. No.: 12/396,456

(22) Filed: Mar. 2, 2009

Related U.S. Application Data
(60) Provisional application No. 61/067,901, filed on Mar. 3, 2008.

(51) Int. Cl. G06F 15/16

(52) U.S. Cl. 709/204

(57) ABSTRACT

Methods and systems for assisting individuals arrange meetings such as networking meetings with other individuals at a specified time (or within a specified time range) and at a specified place (or within a specified geographic region). More specifically, methods and systems for allowing individuals to post an invitation to for a meeting on an on-line network.

### RELATED APPLICATION DATA

This application claims priority to Provisional Patent Application Ser. No. 61/067,901, filed Mar. 3, 2008, hereby incorporated by reference.

### BACKGROUND OF THE INVENTION

The present invention relates to improved systems and methods that allow one or more individuals (“inviting individual” or “inviter”) to meet or otherwise network or connect or transact or exchange information, tangibles or intangibles with other individuals.

Several publications are referenced in this application. The references describe the state of the art to which this invention pertains and are hereby incorporated by reference.

There are a variety of on-line networking services that allow users to learn about other users and possibly network with such other users, such as MySpace.com, Friendster.com, Orkut.com, and Plaxo.com. An online social network allows an individual to easily keep track of relationships that the individual has with other people by leveraging the internet. Evite.com allows users to send invitations for specific events to specific individuals selected by the user. Other invite or event related sites include Meetup, Pinng, MyPunchBowl, Amiando, Invitastic, MadeIt, Socializr, ipartee, Renkoo, ImThere, Skobee, Zvents, Zoji, and Windows Live Events. Meetup.com allows users to find “Meetups” with others who share a common interest or cause or create a “Meetup Group” for others to attend. MeetingWave.com is an online tool for networking off-line for business or social purposes. The site provides a way for users to arrange meetings with the people they'd like to meet—anytime, anyplace—whether traveling or near home or work.

U.S. Pat. Nos. 6,963,900 and 7,483,946 to Boyd and PCT Patent Publication WO 2008/030729, commonly assigned with the present application and hereby incorporated by reference, disclose systems and methods that allow individuals to meet and network with other individuals at a specified time and place. According to the patented invention, a first user “posts” an invitation for a meeting which includes a proposed time (or time range) and place for the meeting and, if desired, any preferences or criteria such as who the first user is interested in meeting with (e.g., a computer scientist, an attorney, a resident from a particular city, alumni from a particular college, etc.). The “invitation” is reviewed by such users. When one or more users “accept” the “invitation”, a meeting may be established.

### SUMMARY OF THE INVENTION

The present invention relates to improved systems and methods that allow one or more individuals (“inviting individual” or “inviter”) to meet or otherwise network or connect or transact or exchange information, tangibles or intangibles with other individuals.

The improvements of the present invention can be applied to or used with the systems and methods set forth in PCT/US2007/076955, filed Aug. 28, 2007 (now PCT Patent Publication WO 2008/030729), commonly assigned and hereby incorporated by reference, specifically, the systems and methods that allow one or more individuals (“inviting individual” or “inviter”) to meet or otherwise network or connect or exchange information, tangibles or intangibles with other individuals by creating and posting an electronic invitation including proposed meeting information (e.g., a specified time or time range, specific location or general location (e.g., neighborhood, zip code), purpose, etc.) or a request for an invitation at a website or other electronic location accessible by other users via the Internet or other computer-based network and allowing other individuals to review such invitations or requests, as specifically described on pages 4-37 of the application specification, hereby incorporated by reference.

One aspect of the invention relates to improved systems and methods allowing the inviter or inviting user to more readily or easily edit or otherwise take action (e.g., approve or decline an acceptance from another user) with respect to an invite.

Another aspect of the invention relates to improved systems and methods of generating and using recurring, standing or open invites.

Another aspect of the invention relates to systems or methods which provide the inviter with improved invite options when generating an invite.

A still further aspect of the invention relates to systems and methods of connecting one or more users, which employs additional steps before a meeting is confirmed and/or wherein the inviter can customize the steps for forming a meeting or other transaction.

A still further aspect of the invention relates to systems and methods of arranging or facilitating the meeting of one or more users with one or more commercial users.

A still further aspect of the invention relates to systems and methods of facilitating the formation of organizations including their leadership structures, voting structures and other organization characteristics.

Other aspects as well as embodiments, features and advantages of the present invention will become apparent from a study of the present specification, including the drawings, claims and specific examples.

### BRIEF DESCRIPTION OF THE DRAWINGS

FIG. 1 is a block diagram that depicts a system architecture in accordance with an embodiment of the present invention.

FIG. 2 is a process flow diagram for rule-based invitation creation in accordance with an embodiment of the present invention.

FIG. 3 is a process flow diagram for rule-based invitation acceptance in accordance with an embodiment of the present invention.

FIG. 4 is a process flow diagram for rule-based invitation counterproposing in accordance with an embodiment of the present invention.

FIG. 5 is a process flow diagram for rule-based invitation browsing in accordance with an embodiment of the present invention.

FIG. 6 is a process flow diagram for rule-based invitation activity notification in accordance with an embodiment of the present invention.

FIG. 7 is a process flow diagram for requests for invitations in accordance with an embodiment of the present invention.

FIG. 8 is a process flow diagram for integrating vendor options into invitations in accordance with an embodiment of the present invention.

FIG. 9 is a block diagram that depicts a computing device in accordance with an embodiment of the present invention.

### DETAILED DESCRIPTION

The present invention relates to improved systems and methods that allow one or more individuals (“inviting individual” or “inviter”) to meet or otherwise network or connect or transact or exchange information, tangibles or intangibles with one or more other individuals. Preferably, using two or more computer devices, one or more (preferably two or more) data processing systems or data networks, and/or results in data transformation as invites to proposed meetings are created, edited, accepted, modified or otherwise transformed electronically.

One aspect of the invention relates to a computer-based method for arranging a meeting or other event between two or more users comprising:

(a) receiving a proposed invitation from an inviter (e.g., an invitation generated by the inviter); and

(b) providing or displaying said proposed invitation information at a location accessible by one or more users. The meeting can be virtual or face-to-face. Preferably, the meeting is a face-to-face meeting.

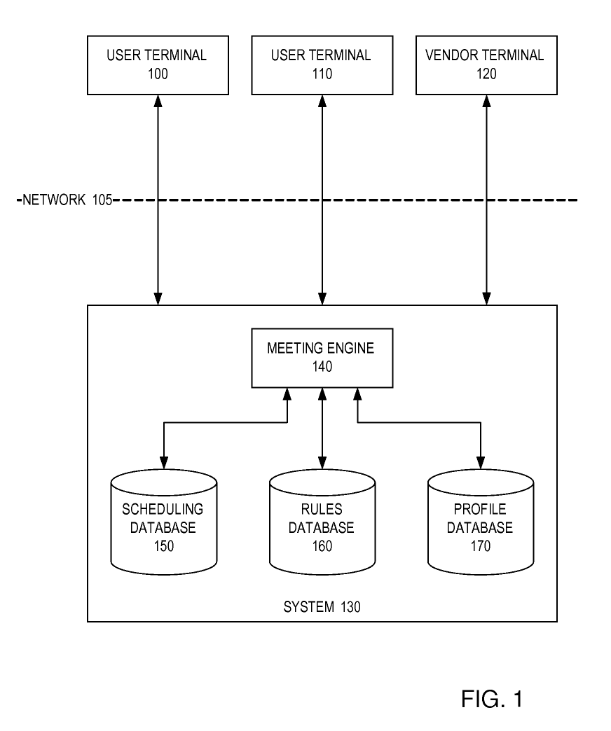

FIG. 1 depicts a system architecture in accordance with an embodiment of the present invention. The architecture may include terminals operated by users (100,110) and/or vendors (120) in communication with the system (130) of the present invention, which may include a meeting engine (140) coupled with several databases that store invitation information (150), processing rules (160) and user/vendor profiles (170).

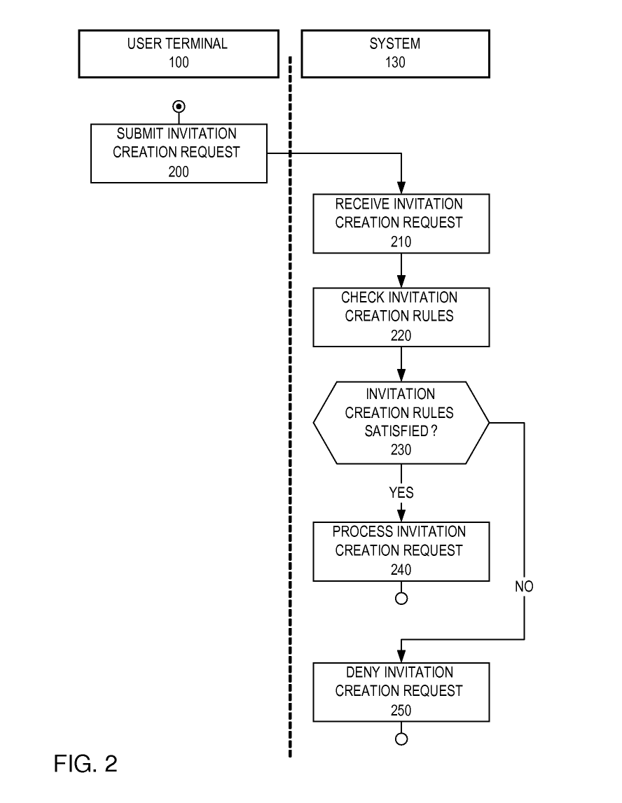

FIGS. 2-5 depict the application of rules by the meeting engine (140) of the system (130) in connection with invitation creation, acceptance, counterproposing and browsing.

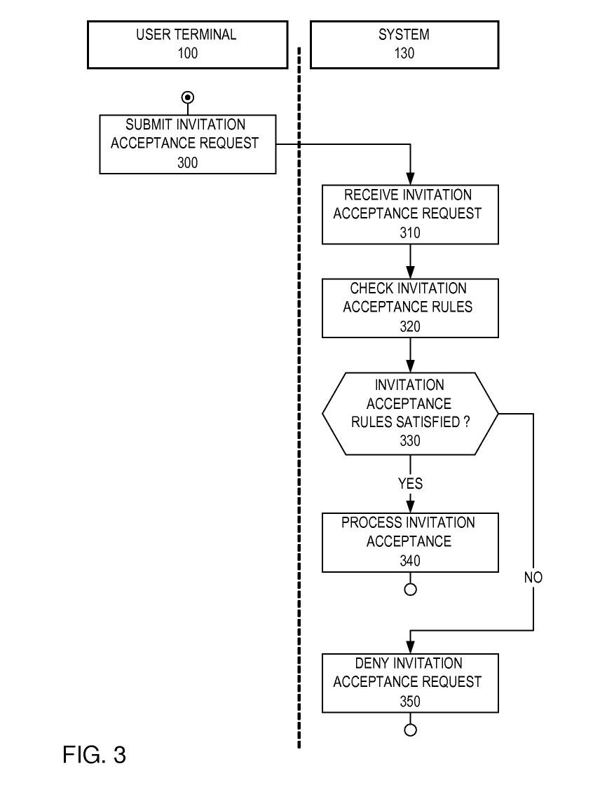

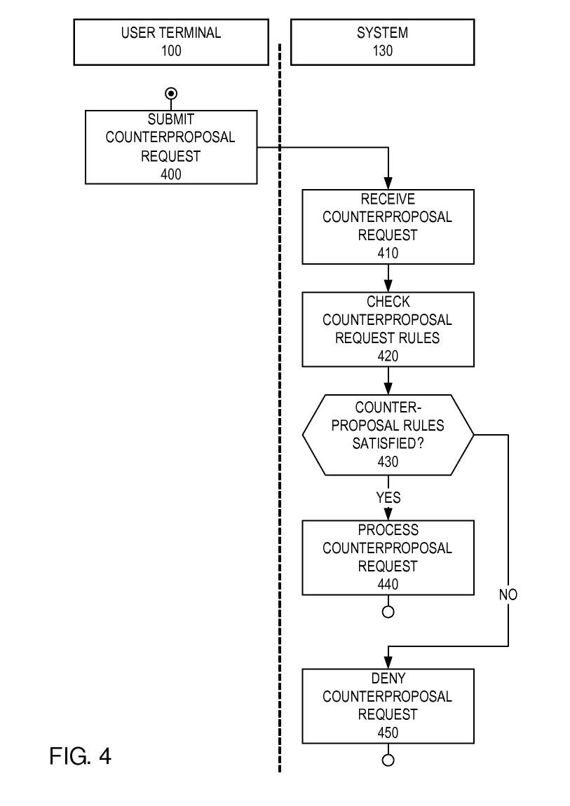

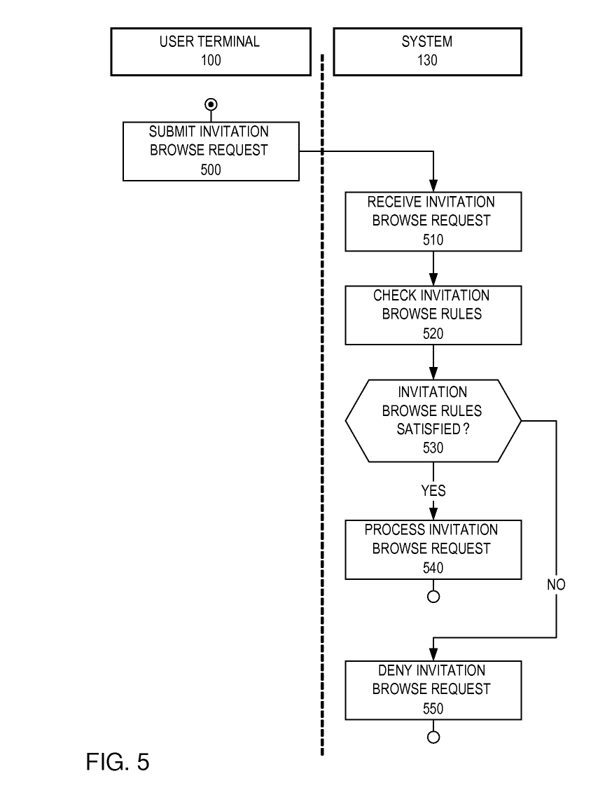

In FIG. 2, a terminal (100) operated by a user submits (step 200) to the system (130) a request over a network (105) to create an invitation for a proposed meeting. The system (130) receives (step 210) the request and determines (steps 220, 230) whether one or more rules associated with invitation creation, such as those stored in a rules database (160), apply to the invitation creation request. The system (130) then processes (step 240) the invitation creation request if all determined applicable (e.g., required or necessary rules) rules are satisfied, and denies (step 250) the invitation creation request if any determined applicable rule is not satisfied. FIGS. 3-5 depict similar steps in connection with invitation acceptance, counterproposing and browsing, respectively. In FIG. 3, a terminal (100) operated by a user submits (300) a request to accept an invitation. The system (130) receives (step 310) the request and determines (steps 320, 330) whether one or more rules, such as those stored in the rules database (160), apply to the request to accept the invitation. The system (130) then processes (step 340) the invitation acceptance request if all the applicable rules are satisfied, and denies (step 350) the invitation acceptance request if any applicable rule is not satisfied. In FIG. 4, a terminal (100) operated by a user submits (400) a request to make a counterproposal to an invitation. The system (130) receives (step 410) the request and determines (steps 420, 430) whether one or more rules, such as those stored in the rules database (160), apply to the request to make the counterproposal. The system (130) then processes (step 440) the counterproposal request if all the applicable rules are satisfied, and denies (step 450) the counterproposal request if any applicable rule is not satisfied. In FIG. 5, a terminal (100) operated by a user submits (500) a request to browse for invitation. The system (130) receives (step 510) the request and determines (steps 520, 530) whether one or more rules, such as those stored in the rules database (160), apply to the request to browse for invitations. The system (130) then processes (step 540) the browse request if all the applicable rules are satisfied, and denies (step 350) the browse request if any applicable rule is not satisfied.

The rules described in FIGS. 2-5 may derive from preferences stored in profiles (170) associated with users and/or vendors affiliated with the system (130), security criteria, and other situations as described below for example.

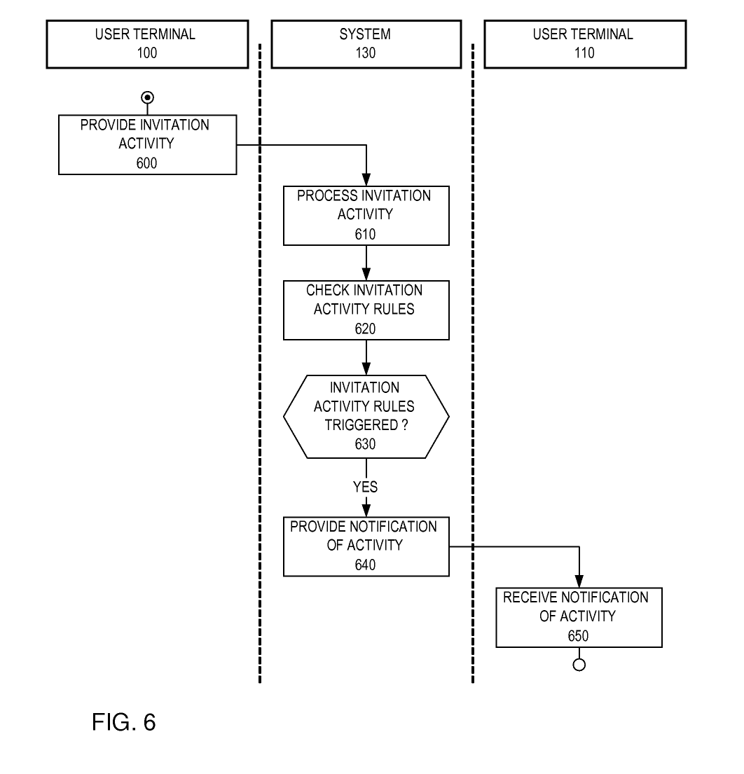

FIG. 6 depicts how a user of the system (130) may express a preference for and receive notification of invitation activity pertaining to invitations of other users that are not related to the inquiring user. Invitation activity may include the posting of an invitation or the acceptance of an invitation by another user, or the posting of an invitation having certain characteristics or keywords (e.g., any invitation for Web 2.0 programmers). For example, a user may wish to be notified when a certain other user (e.g., a user the first user wishes to meet or meet again) posts an invitation or accepts an invitation of another, in which case the first user may be notified so the first user can decide whether to participate in the same meeting. Preferably, the notifications are by email, RSS, SMS, IM or the like.

In FIG. 6, a terminal (100) operated by a user provides (step 600) to the system (130) a request over a network (105) to process an invitation for a proposed meeting, which may include, for example, drafting, creating, editing, accepting, or counter proposing to the invitation. The system (130) processes (step 610) the request, and determines (steps 620, 630) whether the request applies to one or more notification rules set up by a different user unrelated to the processing of the invitation. For example, a notification rule can include a request that the user be notified if a specific user posts or accepts an invite and/or if an invite having certain characteristics is processed (e.g., specific keyword, location and/or meeting purpose). Preferably, the notification employs email, RSS, SMS, IM or the like. It then provides (step 640) to the different user (step 650) a notification in accordance with any determined applicable rule. The notification rules may also derive from preferences stored in profiles (170) associated with users and/or vendors affiliated with the system (130), and examples of such notification rules are provided below.

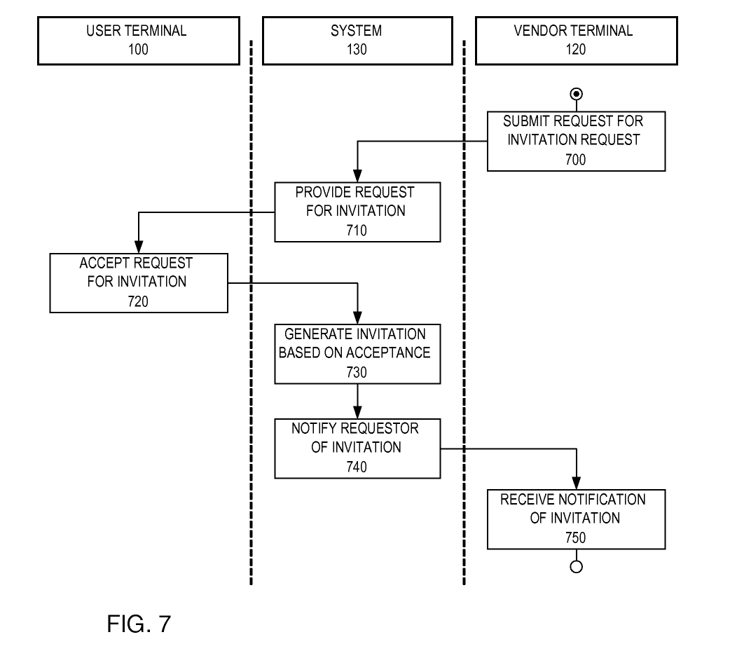

FIG. 7 depicts how vendors may advertise by requesting invitations through the system (130). In FIG. 7, a terminal (120) operated by a vendor submits (step 700) to the system (130) a request over a network (105) for an invitation for a proposed meeting. The system (130) provides (step 710) the request for the invitation to other users. Responsive to a terminal (100) operated by a user accepting (step 720) the request for the invitation, the system (130) generates (step 730) the invitation for the proposed meeting, and notifies (step 740) the vendor (step 750) of the invitation. The initial request for the invitation provided to the other users may be in the form of an online advertisement such as banner ad, for example, as described below.

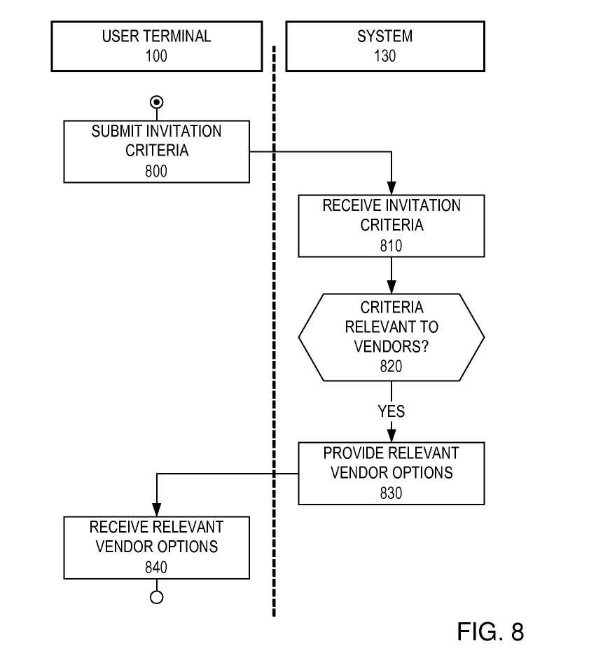

FIG. 8 depicts the integration of vendor (commercial user) service options into invitations. In FIG. 8, a terminal (100) operated by a user submits (step 800) to the system (130) criteria over a network (105) associated with an invitation for a proposed meeting. The system (130) receives (step 810) the invitation criteria and determines (step 820) whether it is relevant to one or more services provided by one or more vendors. The system (130) then provides (step 830) the user (step 840) with an option to select any of the determined relevant vendor services in connection with the invitation. Embodiments of this functionality are provided below. A vendor or commercial user is a user of the system who is seeking to sell or otherwise commercialize goods or services to other users of the system.

One aspect of the invention relates to improved electronic invitations, and methods and systems for generating and/or electronically publishing and/or otherwise transmitting (e.g., via email, RSS, IM, SMS) such invitations or notifications or comments regarding the same.

According to one embodiment, the improved invitations include certain invite information and meeting purposes as set forth on pages 7-11 of PCT/US2007/76955, filed Aug. 28, 2007, commonly assigned and hereby incorporated by reference. Reference is also made to U.S. Provisional Application No. 61/067,901, filed Mar. 3, 2008, commonly assigned and hereby incorporated by reference.

One aspect of the invention relates to improved systems and methods allowing the inviter or inviting user to more readily or easily edit or otherwise take action (e.g., approve or decline an acceptance from another user) with respect to an invite. Preferably, using two or more computer devices, one or more (preferably two or more) data processing systems or data networks, and/or results in data transformation as invites to proposed meetings are created, edited, accepted, modified or otherwise transformed electronically.

According to one embodiment, the invite may include at least the following details regarding the proposed meeting: (a) time; (b) date; (c) location; and (d) invitee or guest list. Preferably, the inviter may select to edit less then all of the invite content. For example, the inviter may have posted an invite but may now wish to change only the time of the proposed meeting and would therefore be able to select to edit just the time component of the invite rather then the entire invite. As another example, the inviter may wish to edit only the location or invitee list. Preferably, each invite component can be selectively edited. This is particularly advantageous if the invite content includes not only (a), (b) and (c), but also additional content such as a meeting description, invitee description, guests/invitees, photos, etc. If the inviter is only able to edit the entire invite at a time, the inviter would be required to load and/or open the entire invite form for editing. If the inviter is accessing the system using a handheld device such as a cell phone or Blackberry device, loading the entire invite form may be time consuming. Therefore, the ability to selectively edit a portion of the invite details at a time would be advantageous to the user.

According to one embodiment, the inviter can select or otherwise identify a portion or single invite component (e.g., the time, date or location) for editing without having to open the entire invite. One preferred embodiment relates to a method for arranging meetings between two or more users, comprising:

receiving by a server a request from a first user over a network to edit an invite for a proposed meeting;

determining whether one or more rules associated with invite editing apply to the request from the first user to edit the invite;

processing the edit request if all rules determined to be applicable are satisfied; and

denying the request if one or more rules determined to be applicable are not satisfied;

wherein:

said request to edit said invite specifies a portion of the invite for editing, providing said portion of said invite to said first user to edit, receiving edits from said first user and incorporating said edits into said invite. According to one preferred embodiment, the inviter can select two or more portions or components (e.g., the time, date, location and/or invitee list) for editing without having to open or download the entire invite.

Preferably, the inviter can selectively save each edit separately or save all edits at once. According to one embodiment, the inviter may individually select which components of the invite require editing and thereby be provided with only those selected portions for editing.

According to another embodiment, the inviter can email the system with the proposed edit(s) and the edits are then incorporated into the invite. Preferably, the user can prompt the system to send a list of the user's upcoming invites, and preferably the user can select a single invite and submit a proposed edit for that selected invite via email. Preferably, the system sends out a reminder regarding the meeting and the inviter can opt to reply with any invite edits via email.

According to another preferred embodiment, a notification (e.g., email, RSS, SMS, IM, etc.) is sent to the attendees or guests of the meeting that includes the updated invite information. For example, if one or more users have accepted the invite, they are notified if any changes to the invite are made (e.g., via email). Preferably, each attendee is able to confirm that the changes are acceptable (e.g., they can still attend the meeting at the new location), preferably each attendee can selectively confirm/deny and/or comment regarding each change (e.g., an attendee can indicate the change of venue is acceptable, but the change of time is not). Preferably, the inviter can select to request that the attendees confirm that the changes are acceptable.

According to another embodiment, the inviter can edit one or more portions of the invite (e.g., time, date or location) by deleting the information and rather then replacing the information, the inviter can select to have a notification sent to one or more attendees requesting their input or suggestions (e.g., for a revised time or location). Preferably, one or more attendees can input replacement invite information and a notification will be forwarded to the inviter and, optionally, the other attendees for their confirmation or further input. Preferably, the inviter can select that one or more but not all of the attendees receive the change notification and a request for suggestions. Once the revised information is agreed upon, the remaining attendees may be notified of the revised invite information. Preferably, if the invite is a public invite, the published invite is updated once the revisions are finalized.

According to another embodiment, the inviter is able to take an action (e.g., approve or decline an acceptance from another user) with respect to an invite without opening or loading the entire invite. Preferably, the inviter is notified of acceptances by other users with an invite description containing less then all of the invite information and the inviter is able to approve or decline without opening or viewing the entire invite. One preferred embodiment relates to a method for arranging meetings between a first user and a second user, comprising:

receiving by a server an acceptance of an invite for a proposed meeting from said second user over a network;

determining whether one or more rules associated with said invite apply to the acceptance;

processing the acceptance if all rules determined to be applicable are satisfied; and

denying the acceptance if one or more rules determined to be applicable are not satisfied;

wherein:

a notification of said acceptance is sent to said first user and said first user can approve or decline said acceptance without downloading, displaying or otherwise accessing said invite.

Preferably, the inviter first receives a notification that someone has accepted the inviter's invite, the inviter may then select to view the acceptor's username and/or profile, and then may further select to view the invite details prior to approving or declining the acceptor's acceptances. According to another embodiment, the inviter can select to receive a simple notice that someone has accepted an outstanding invite and can then choose to view the underlying details including information about the accepting user and the invite information.

Another aspect of the invention relates to methods and systems that further notify the inviter of the status of outstanding invitees via a notification (e.g., email, RSS, IM, SMS, etc.) and/or forwards a copy of the invite details to the inviter so such details can be forwarded to the invitees by the inviter. According to one embodiment, the inviter is immediately sent a copy of the invite either when the invite is first posted or after a period of time to allow the inviter to directly send the invite details to invitees. This advantageously avoids spam filters if sent via email since the inviter's invitees will typically have the inviter's email address and thus their SPAM filters will not block. The recipients can then be notified of the invite and register with the system so that emails from the system are directly received in the future. Preferably, the inviter is sent a notification regarding the status of invitees (e.g., accepted invite, declined, received email, opened email, etc.) so the inviter can know whether to follow-up with each individual invited. Preferably, the methods and systems use two or more computer devices, one or more (preferably two or more) data processing systems or data networks, and/or results in data transformation as invites to proposed meetings are created, edited, accepted, modified or otherwise transformed electronically.

Another aspect of the invention relates to systems or methods where the inviting user can customize the invite creation form, preferably being able to add or delete fields and/or customize the design of the invite. For example, the inviter may create an invite form adapted for arranging a teleconference or web conference or online chat meetings and therefore wish to delete fields such as address from the invite form. As another example, the user may wish to add fields to the invite form such as fields for uploading photos or other content. According to one embodiment, the invite form is adapted for inviters who are realtors and allows them to upload photos and videos of the property as well as other information. Preferably, the inviter may also include requirements from acceptors. For example, realtors may choose to add a requirement that acceptors describe the status of their search (i.e., if potential home buyers), whether they are renters or current home owners, their occupation, income range, home style interests or preferences, etc., resulting in an invite that requires completing these fields before other users accept the invite. Preferably, the methods and systems use two or more computer devices, one or more (preferably two or more) data processing systems or data networks, and/or results in data transformation as invites to proposed meetings are created, edited, accepted, modified or otherwise transformed electronically.

Yet another aspect of the invention relates to systems and methods of generating meeting invites adapted or configured for use by conference or trade show attendees, alumni or trade association or other large entities for arranging networking meetings within those groups of people. One preferred embodiment relates to methods or systems that can integrate with the conference's, tradeshow's or association's method or system. Preferably, the platform system is able to sync with the schedule of the conference so the user can be informed of optimal times (e.g., breaks between sessions) for proposing a networking meeting with other attendees. Preferably, the system and methods are closed to conference or tradeshow registered attendees or members of the association or other entity. Preferably, the system includes venue feed for attendees or conference organizer to add a map or local venues for networking meetings. Preferably, users, organizers or vendors can include menu, discounts, ratings and related information. According to one preferred embodiment, the conference organizer or other third party is able to customize the invite form, user profiles and other attributes of the system. For example, a conference organizer may wish to input a range of dates available for networking at the conference, possible venues within and near the conference venue and customize the profile pages for conference attendees. Preferably, the users can post invitations with dates and venue locations confined to the tradeshow or conference (e.g., user selects a time within the time range of the event and venues near or within the event). Preferably, the inviter can target other attendees based on the sessions attended, meeting interests, etc. Preferably, the entity can utilize the entities user profiles with the system or method. Preferably, the methods and systems use two or more computer devices, one or more (preferably two or more) data processing systems or data networks, and/or results in data transformation as invites to proposed meetings are created, edited, accepted, modified or otherwise transformed electronically.

Another aspect of the invention relates to systems or methods which provide the inviter with improved invite options when generating an invite. According to another embodiment, the systems or methods provide the inviter with the following options when generating an invite: (a) Public (e.g. published on a website) or Private (i.e., not published); and (b) RSVPs required or not required.

According to another embodiment, the systems or methods provide the inviter with the following options when generating an invite: (a) Public (e.g. published on a website) or Private (i.e., not published); (b) RSVPs required or not required; and (c) inviter approval required to confirm invitee can attend or inviter approval not required.

According to yet another embodiment, the systems or methods provide the inviter with the following options when generating an invite:

(a) Level of Third Party Accessibility: (i) Public (e.g. published on a website) or (ii) Private (i.e., not published, only certain individuals (e.g., registered users, contacts, friends, other users based on profiles, rankings, etc.) can view);

(b) Invitee Preference, preferably (i) no preference; (ii) invite friends or contacts; (iii) specify that invitee profile required; and/or (iv) describe the type of people the user wants to meet (preferably a matching profile required to accept the invite);

(c) invitee commitment Level (i) no need to RSVP (e.g., can just show up) or (ii) need to RSVP or otherwise indicate an interest in attending; and

(d) Inviter Approval Requirement (i) inviter approval required to confirm invitee can attend or (ii) Inviter approval not required (RSVP confirms can attend).

According to preferred embodiments of the invention, the inviter or meeting organizer may “approve” or “decline” another user's acceptance of the invite. According to another embodiment, if a specific person is invited to attend a meeting, the inviter would not need to “approve” that person's acceptance in order for that person to receive confirmation that he may attend the meeting since the system will assume that if the inviter has specified someone to invite, the inviter would not have any reason to decline that person's acceptance.

A still further aspect of the invention relates to systems and methods of connecting one or more users, wherein the inviter can customize the steps for forming a meeting or other transaction. For example, in addition to the steps of posting a public invite, receiving an acceptance from an accepting user and approving the acceptance to confirm the meeting, the inviter may select to require one or more additional steps before or after the confirmation of the meeting or other transaction. Preferably, the methods and systems use two or more computer devices, one or more (preferably two or more) data processing systems or data networks, and/or results in data transformation as invites to proposed meetings are created, edited, accepted, modified or otherwise transformed electronically.

According to one embodiment, the invite is posted by a first user, a second user transmits an initial indication of interest to the first user, the inviter then discloses additional information regarding the inviter, the proposed meeting or transaction or other information to the second user, the second user may then accept the invite and, finally, preferably the inviter confirms acceptance to result in the meeting or transaction. For example, a posting for a job, car sale, home sale, etc. and the inviter may not wish to commit to a meeting until additional information has been received and/or transmitted to the other user. For example, a company may wish to replace a current executive and post a job listing, but may not wish to disclose the companies name or industry. The company may post an invite for a recruitment meeting without disclosing identifiable information about the company. A potential replacement may then accept the invite and after such acceptance the company may then disclose information regarding the company and the position, and then the replacement may accept the invite to the proposed meeting. Similarly, a job seeker may wish to accept the invite but also may be reluctant to disclose information for fear of losing current job. The job seeker may accept the company's invite, and after the company reviews the job seekers basic profile may disclose more information and after additional optional back and forth a meeting is formed. Another example may involve a proposed meeting involving the sale of a car where the inviter may not wish to disclose all information (e.g., location of the car) or confirm a meeting with an interested buyer until certain information is received from the buyer. Another embodiment relates to facilitating the scheduling of meetings for two or more meeting participants. Preferably, each participant can provide one or more proposed times and/or proposed locations and the system selects one or more optimal times/locations to propose to the participants.

According to another embodiment, the inviter is able to post an invite where the time and/or date is left open such that the invitation stays open until the designated number of users accept (and the users may than choose a time and date) or until a first accepting user proposes a time/date. That is, the inviter posts an open invitation and the proposed time is selected by the accepting user and then confirmed by the inviter. According to one preferred embodiment, the inviter may set a time limit for the recurring or standing invite (e.g., limit to twenty recurring dates) or allow the invite to continue until cancelled.

Another aspect of the invention relates to improved systems and methods of generating recurring, standing or open invites whereby the inviter or inviting user can select one or more dates or a range of dates within the range of dates of a recurring or open invite and either (i) cancel/delete, (ii) pause or (iii) edit the invite for such dates, while allowing the remaining recurring or open dates to remain unchanged and available for acceptance by other users. For example, an inviter may post a recurring invite or an open date invite for coffee at noon near the inviter's office as the inviter is generally available at this time to meet with others. The inviter can keep the invite pending over time allowing other users to accept any of open dates. According to this aspect of the invention, the inviter may selectively delete or pause or edit the invite for one or more dates. For example, the inviter may pause the recurring invite for a week or another period of time or completely pause all dates (i.e. delete any dates going forward until the recurring invite is resumed and then “restart” the recurring invite (e.g., the inviter will be on vacation for a week and wishes to pause the invite while away, but restart the invite again once back at the office or indefinitely). According to another embodiment, the inviter may delete or cancel or edit the invite for one or more dates (e.g., the inviter knows he has a conflict the following Tuesday and Friday, he can delete those dates without deleting the other recurring or standing invites or edit the start time without changing the other invites). These features are advantageous since allows an inviter to avoid having a meeting date available for acceptance by others when he knows he's unavailable or changing the invite for all the recurring dates, but instead allows the invite to continue pending for the other dates. Preferably, the methods and systems use two or more computer devices, one or more (preferably two or more) data processing systems or data networks, and/or results in data transformation as invites to proposed meetings are created, edited, accepted, modified or otherwise transformed electronically.

Another aspect of the invention relates to improved systems and methods of using open or standing invites, including invitations posted without a proposed time, date and/or specific location. Preferably, such open or standing invites include a description of the purpose of the proposed meeting, a description of the people the user posting the invite wishes to meet, and/or a description or profile of the user posting the invite. These invites or requests for invites are indications by a first user to the other users of the first user's availability for and interest in a meeting. Preferably, the other users can search, access or review such standing or open invites and, if interested, accept the invite. Preferably, other users can select to view recurring invites as single invites (as opposed to multiple recurring date invites) when viewed in search results. Preferably, a notification is then sent to the first user that another user has accepted the standing invite. Preferably, the other user can select a time, date and/or location and that information is forwarded to the inviter of the standing invite. Preferably, the first user can confirm his or her availability and, if confirmed, a notification is sent to the other user. Preferably, the user posting the standing invite can either (i) cancel/delete, (ii) pause or (iii) edit the invite for one or more dates, while allowing the remaining invite dates to remain unchanged and available for acceptance by other users. For example, a standing invite may be posted as being open for any date, this will allow such an inviter to delete or cross-out certain dates the inviter knows will not be available.

Another aspect of the invention relates to systems or methods of generating invites or notifications to suggest the creation of invites based on user profile information, a user's meeting history and details and/or comments regarding such meetings, and specified meeting interests. For example, two user's may each indicate “coin collecting” as “meeting interests”. The system will preferably notify one or both users of each others interests so each can consider inviting the other to a networking meeting. Preferably, this is achieved also using the proximity of the users, preferably using geolocation technology (e.g., the member location provided by electronic device such as cell phone, iphone, Blackberry device or the like). According to one preferred embodiment, users can “opt out” of receiving such notices or participating. According to another embodiment of the invention, a first user may create a profile or otherwise indicate a meeting interest on the system and the system will generate a notice to the first user of other user's with similar interests and/or notify other users with similar interests of the first user. Preferably, the notification enables the recipient to create an invite to the other user and said invite is transmitted to the other user. Preferably, the users are able to send notifications or invites to proposed meetings to each other without knowing their specific locations. Preferably, each user is capable to assign a time and location radius to their profile and be notified of other users or proposed meetings of interest based on the user's time/location radius. For example, a user may choose to be notified of any meeting relating to “green technology” or another user including “green technology” as a meeting interest within 5 miles of the user's location and for meetings, taking place within the next 24 hours. If the user travels to a location and there is another user or meeting satisfying those requirements, the user will be notified and can either accept the meeting invite and/or invite the other user to a meeting, as applicable.

According to one embodiment, the one or more users are anonymous in that the user posting the invite (“inviter” or “inviting user”) does not previously know the one or more users accepting the invitation (“acceptor” or “accepting user”). For example, the users may all be anonymous users. The term “anonymous” as used herein is intended to refer to anonymity between the two or more parties. One form of anonymity involves “shielded identity”, where a trusted agent (e.g., the system) may know the identity or personally identifiable information (e.g., email address) of the two or more parties, but does not reveal that identity to others except under specified circumstances. Unless otherwise specified, the term “anonymity” is used throughout this application interchangeably with the notion of shielded identity. See, U.S. Pat. No. 6,023,510 to Epstein; U.S. Pat. No. 5,884,272 to Walker et al; U.S. Pat. No. 5,958,007 to Lee et al.; U.S. Pat. No. 5,884,270 to Walker et al.; and U.S. Pat. No. 6,012,046 to Lubien et al. According to preferred embodiments of the invention, the system or method provides users with “shielded identity” anonymity in that the system knows the user's name or contact information (e.g., email address), but this information is not available to other users. According to other preferred embodiments, the users are not anonymous (e.g., their names or other personal identifiable information is disclosed in their profiles), but the users did not previously know each other.

Preferably, the user's homepage or dashboard includes information relating to or lists of the other users the user has either met with or is interested in meeting with or meeting interests. According to one preferred embodiment, a user may request to be notified (e.g., via email) if a particular user posts an invitation or has accepted another invitation or if a certain type of invitation has been posted. For example, a user may live in NYC and want to be notified if any dinner invite is posted involving business-networking for corporate attorneys. As another example, the user may wish to be notified if an invitation is posted or accepted by another specific user or if a meeting having certain characteristics is posted. Preferably, the user is able to limit the notifications by geographic regions and/or within a certain distance of the user's present or future scheduled location (e.g., if the user's information indicates he will be traveling to Dallas the following week, the system will notify the user of invites in Dallas the following week meeting the user's interests). Suitable wireless devices and technologies are set forth on pages 18-20 (paragraph 0066) of PCT/US2007/76955, hereby incorporated by reference.

According to one preferred embodiment, the system allows the individual to initially answer a number of questions or input menus about him or herself to construct the individuals profile for their personal webpage. According to one preferred embodiment, the system notifies the user of other users having similar interests (e.g., meeting interests), preferably, within a specific location range relative to the user. Preferably, the user can opt-in or opt-out of such notifications and set the parameters of when and how he will be notified. Preferably, the notification can include a template or link to a template of initiating an invite to a proposed meeting with the other user.

Another aspect of the invention relates to improved methods and systems that allow users to search for invitations of interest.

Another aspect of the invention relates to improved systems and methods that would allow the users to communicate with each other, preferably anonymously and/or without knowing each other's email address or other contact information. Preferably, the methods and systems use two or more computer devices, one or more (preferably two or more) data processing systems or data networks, and/or results in data transformation as invites to proposed meetings are created, edited, accepted, modified or otherwise transformed electronically.

According to one embodiment, the inviter can designate in an invitation or the inviter's profile, preferably as a default, as the invite allowing for responses or questions or comments from the other users, and preferably designate whether such responses, questions or comments are posted with the invitation on the inviter's dashboard or publicly on the site and/or sent directly to the inviter's email address or the inviter's profile page (e.g., the user's “myprofile” page). According to another embodiment, such functionality or feature is automatically provided to the user. One advantage of this functionality would be the ability of the users to better communicate about a proposed invitation, about an upcoming meeting, about a past meeting, or on any other topic. Preferably, the inviter can select whether the messages are private (e.g., viewable only by meeting participants or just to one or more participants but not all) or public (e.g., viewable by any user). Preferably, an inviter has the option to communicate with any accepting user or pre-selected users and/or to communicate with only confirmed meeting participants or with one or more selected users. Preferably, the system allows accepting users to communicate with the inviter and confirmed meeting participants to communicate with one or more of the inviter and/or other confirmed meeting participants. Preferably, the communications are via double-blind emails and/or viewable via the invite. Preferably, the inviter and/or meeting participants/invitees can select to archive for their future records and/or continue communicating after the meeting has occurred. Preferably, the accepting users to may send messages to (a) confirmed attendees (including the invite) and (b) any accepting user (confirmed or not yet confirmed). Preferably, the inviter has the ability to select the level of intra-invite communication between users, such as (i) only inviter to non-inviter messaging (e.g., users invited or users who've accepted the invite); (ii) approved/confirmed attendees can message other approved/confirmed attendees (either one or more or all) and the inviter; (iii) approved/confirmed attendees can message any accepting user and the inviter; (iv) any accepting user can message any other accepting user; and (v) any user can communicate with any user associated with the invite. Preferably, the inviter can choose whether he must be cc'd or bcc'd in any message according to (i)-(v).

Another aspect of the invention relates to methods and systems of arranging or facilitating the meeting of one or more users with one or more commercial users. Commercial users include service providers (e.g., attorneys, realtors, financial planners, consultants, doctors, therapists, etc.) and/or representatives or affiliates of firms, vendors or companies (e.g., sales, marketers, etc.). Preferably, the methods and systems use two or more computer devices, one or more (preferably two or more) data processing systems or data networks, and/or results in data transformation as invites to proposed meetings are created, edited, accepted, modified or otherwise transformed electronically.

One embodiment of the invention relates to invites posted by commercial users. According to one embodiment, commercial users post invites targeting potential clients or customers and/or describing their services or products. Users browsing or searching for invites may receive in the search results relevant invites from commercial users. The requests for invitation may be banner advertisements or in another form suitable for inclusion in the search results. Preferably, the commercial invites are “labeled differently” compared to non-commercial invites or otherwise readily identified as commercial invites. In another embodiment, the user who submits a request to browse for invitations may indicate that the search should encompass only noncommercial invitations (i.e., exclude commercial invites) or should include both invitations and commercial invitations, or should include only commercial invitations. Preferably, users can screen search results or readily identify invites that offer compensation for accepting and attending the meeting (e.g., invitor will pay for coffee or lunch, offers compensation for attending, etc.).

Another aspect of the invention relates to online messages or advertisements (e.g., banner ads, interactive ads, etc.) which when clicked by a user will help them set up an invite or meeting (“ad-generated invite”) or present a form to be completed to create such an invite to meet with a commercial user or vendor. Preferably, the ads are interactive in that they receive user input (e.g., email, location, etc.). Such a message or advertisement can be a “request for invitation” in that it is an open request for another user (e.g., a potential client) to click to request an invite for a meeting. For example, a banner ad may state “Meet with a State Farm Insurance Agent—We'll buy the Coffee” and when a user clicks or otherwise selects the ad, an ad-generated invite or invite form to meet with a representative of the advertiser is automatically generated or displayed to the user. Preferably, the user provides a time and/or location or generally indicates when and where available for a proposed meeting and the ad-generated invitation is transmitted to the advertiser. Preferably, the ad-generated invitation automatically fills in the user's profile information (e.g., background, location), if known, preferably as default information (e.g., the user can change the location if they wish to meet at another location). Alternatively, the user can fill in the time and location for the proposed meeting. Accordingly to one preferred embodiment, the user merely inputs contact information (e.g., phone or email) and a zip code/location. According to another preferred embodiment, the user inputs contact information (e.g., phone or email), a zip code/location and proposed time(s) for a proposed meeting. According to another preferred embodiment, the user inputs contact information (e.g., phone or email), a zip code/location, proposed time(s) for a proposed meeting and a description of the user's needs or background information. According to one embodiment, the “meeting” can be via phone, online chat or the like (i.e., not an in-person meeting) and the user inputs contact information (e.g., email or phone). Preferably, the advertiser or the advertiser's agents or representatives are notified (e.g., via mail) that a user has generated such an invite for a meeting so that an employee or representative can be assigned to meet with the user. Preferably, the advertiser, employer or representative accepts the invite to a meeting and such acceptance is transmitted (e.g., via email, etc.) to the user confirming the meeting. Preferably, the user and/or advertiser, employee or representative can communicate via double-blind email or the like.

Methods and systems relating to Commercial Users are set forth in paragraphs [00122-00123] of PCT/US2007/076955, filed Aug. 28, 2007 (now PCT Patent Publication WO 2008/030729), hereby incorporated by reference. Preferably, the user can set a time limit for acceptance by any commercial user. Preferably, if a user rejects or declines the acceptance, the invite can be resubmitted for other Commercial Users to accept. Preferably, the user is provided with the option to resubmit the invite. Examples of interactive banner technologies that can employed in the current invention to deliver, display and control the ads and retrieve data from the users are set forth, for example, in US Pat Publication 20090055254 to Madhavan et al; US Pat Publication 20090037253 to Davidow, et. al.; US Pat Publication 20090048921 to Tokuda et al., each hereby incorporated by reference.

According to one preferred embodiment, the advertisement invitation includes contact information of the user and is transmitted to the commercial user.

According to one embodiment, a user clicking on the ad will be provided with invite form. Preferably, the form requires the user's email address (or username and password, if applicable), phone (optional), location (e.g. zip code), general or specific times available, and a text field for comments.

Once the user submits, the invite notification will go to the advertiser who will then accept or assign an agent to accept. The agent and user can then coordinate meeting planning via a double-blind messaging system.

According to one embodiment, the method and system allows the advertiser to design or construct the banner ad invite that will be displayed to users. Preferably, the advertiser can input or select the text displayed, the design of the ad, upload a logo or design and otherwise construct the banner ad invite. Preferably, the advertiser can also construct and design the invite form displayed to the user when the banner ad is clicked, and any additional pages or graphics displayed to the user. For example, the advertiser may input or select: (a) activity (e.g., coffee, lunch, etc.); (b) time or dates available for meeting; (c) request specified information from the user (e.g., email, phone, residence, occupation, etc.). Preferably, the advertiser can choose whether a confirmation is required or choose that any click submission results in a confirmed meeting.

Preferably, the advertiser may submit bids for the ads based on one or more of: (i) per impression; (ii) per click; (iii) per click with user contact information provided (even if no meeting); (iv) per click with meeting request submitted; and/or (v) per confirmed meeting.

Another aspect of the invention relates to methods and systems of facilitating the placement of banner ad invites on third party publisher sites.

According to one embodiment, a publisher can review a list of available banner ads created or submitted by Commercial Users and select one or more to be exported onto the publishers site. Preferably, the publisher can modify the look and feel of the banner ad to better integrate within the publisher's site. Preferably, the advertiser can place limits on any modifications the publisher can make to the banner ad.

Preferably, the publisher is only paid for actual sales leads or meetings, but not compensated for impressions or clicks, preferably the advertiser makes the decision of whether and how the publisher is paid. Thus, the advertiser will only pay the publisher if an actual sales lead or confirmed meeting is generated by the banner ad reducing the need for the advertiser to control where the ad is displayed. Preferably, the publisher is able to confirm with the advertiser or user whether a sales lead or confirmed meeting occurred.

Preferably, the advertiser is provided with the option to select whether publishers can display the advertisers banner ads without authorization from the advertiser pursuant to this arrangement. Preferably, the advertiser is notified when a publisher selects to display the advertiser's ad before the ad can be display and must approve. According to another embodiment, the advertiser is notified and can stop the ad from being display.

Yet another aspect of the invention relates to improved methods and systems of organizing, managing and governing one or more meeting groups relating to common topics or interests. For example, recurring meetings relating to “green technology” may form a common organization or social network such as a “Meetup Alliance”. According to one embodiment of the invention, one or more members of the organization are prompted to select one or more templates for governing models for the organization including organization structure, voting requirements, membership rights, etc., allowing individuals to self-organize in an orderly fashion. For example, members may select the leadership structure, when voting will occur, who may vote, the organization's constitution, agenda and/or platform. Member's may vote to have a single chair reporting to a board of a specified size and, select a model for selecting each (e.g., each elected by members vs. the board is elected and the board elects the chair, etc.). Organizations can experiment with different structures to optimize the results. Preferably, the method or system provides members with online or computer-based options for each organization characteristic to be determined. This allows members who have never met or otherwise worked together or who are distinct from one another, to readily form an effective organization using an online or computer-based tool. That is, the choosing and selection of organization structure and management can be selected online without using a live or real-time voting of all members. One embodiment of the invention relates to a method for forming (preferably virtually) an organization between two or more users or meeting groups, comprising:

receiving by a server a request from a first user over a network to create an organization, said organization relating to a topic or interest shared among two or more meeting groups;

determining whether one or more rules associated with organization creation apply to the request from the first user to create the organization;

processing the request if all rules determined to be applicable are satisfied; and

denying the request if one or more rules determined to be applicable are not satisfied;

wherein:

said method further comprises transmitting to said first user and one or more other users a request to select or vote on one or more of the following: organization structure, voting requirements, membership rights, and combinations thereof. Preferably, the users are provided with two or more options to choose from for each organization characteristics. Preferably, users may be provided with the option to create custom organization characteristics to include as choices or to use as the sole choices. The advantages would be to allow groups of individuals to form a functioning organization virtually without ever having to meet. Preferably, organizational templates are provided or can be create for the members to choose from. This online tool advantageous provides a structured path for determining the organization's characteristics, including leadership structure, voting requirements, etc., including how often those characteristics should be revisited and re-voted on. Preferably, the methods and systems use two or more computer devices, one or more (preferably two or more) data processing systems or data networks, and/or results in data transformation as invites to proposed meetings are created, edited, accepted, modified or otherwise transformed electronically.

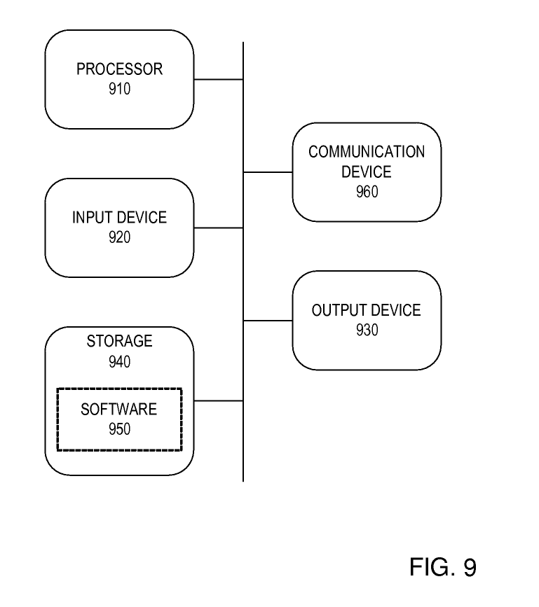

FIG. 9 illustrates the components of a basic computing device in accordance with an embodiment of the present invention; a computing device as depicted may constitute any one or more of the user /vendor terminals (100, 110, 120) and a server running the meeting engine (140), for example. The computing device may be a personal computer, workstation, server, or any other type of microprocessor-based device, including for example a mobile electronic device such as a PDA (personal digital assistant) or a mobile telephone. The computing device may include one or more of a processor (910), input device (920), output device (930), storage (940), and communication device (960).

The input device (920) may include a keyboard, mouse, pen-operated touch screen or monitor, voice-recognition device, or any other device that provides input. The output device (930) may include a monitor, printer, disk drive, speakers, or any other device that provides output.

The storage (940) may include volatile and nonvolatile data storage, including one or more electrical, magnetic or optical memories including such as a RAM, cache, hard drive, CD-ROM drive, tape drive or removable storage disk. The communication device (960) may include a modem, network interface card, or any other device capable of transmitting and receiving signals over a network. The components of the computing device may be connected in any manner, such as via electrical bus or wirelessly.

The software (950), which may be stored in the storage (940) and executed by the processor (910), may include, for example, the application programming that embodies the functionality of the present invention (e.g., as embodied in the meeting engine (140)). The software (950) may include a combination of client applications and enterprise servers such as an application server and a database server.

Communications may occur over any type of network (105), which may implement any communications protocol, which may be secured by any security protocol. Network links may include telephone lines, DSL, cable networks, T1 or T3 lines, wireless network connections, or any other arrangement that implements the transmission and reception of network signals.

The computing device may implement any operating system, such as Windows, Linux or UNIX. The software (950) may be written in any programming language, such as C, C++, Java, Ruby on Rails, Visual Basic and/or SQL. In various embodiments, application software embodying the functionality of the present invention may be deployed on a standalone machine, in a client/server arrangement or through a Web browser as a Web-based application or Web service, for example.

With respect to the appended claims, unless stated otherwise, the term “first” does not, by itself, require that there also be a “second”.

While the particular methods, devices and systems described herein and described in detail are fully capable of attaining the above-described objects and advantages of the invention, it is to be understood that these are the presently preferred embodiments of the invention and are thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “one or more” and not “one and only one”, unless otherwise so recited in the claim.

It will be appreciated that modifications and variations of the invention are covered by the above teachings and within the purview of the appended claims without departing from the spirit and intended scope of the invention. For example, software modules that implement the present invention such as the meeting engine (140) may comprise several discrete modules that together still provide the same functionality, data specified in the illustrated databases (150, 160, 170) may be spread over several databases and/or systems (e.g., a server may be two or more servers acting together) and the flow diagrams of FIGS. 2-8 may encompass combined steps or several intermediate steps that do not detract from the higher level functionality described therein. As used herein and in the appended claims, a “server” should be understood to refer to one server or more than one server.

What is claimed is:

1. A method for arranging meetings between two or more users, comprising:
receiving by a server a request from a first user over a network to create a recurring invitation for a proposed meeting, said recurring invitation recurring daily, any weekday, weekly or monthly;
determining whether one or more rules associated with invitation creation apply to the request from the first user to create the invitation;
processing the request if all rules determined to be applicable are satisfied; and
denying the request if one or more rules determined to be applicable are not satisfied;
wherein:
said method further comprises receiving from said first user one or more of the following requests: (i) pause the recurring invite; (ii) delete one or more individual dates within the range of recurring dates; and (iii) edit the invite information for one or more individual dates without modifying the invite information in the other invite dates.

2. The method of claim 1, wherein:
said server allows other users to view any changes made to any of the invite recurring dates.

3. The method of claim 1, wherein any changes to any recurring invites are transmitted to any users who have previously accepted the invite for the changed recurring date.

4. The method of claim 1, wherein said first user pauses the recurring invite deleting future recurring dates until the recurring invite is resumed by the first user.

5. The method of claim 4, wherein said first user subsequently resumes the recurring invite thus continuing the recurring invite for future dates.

6. The method of claim 1, wherein said first user deletes one or more dates of the recurring invite and any confirmed attendees are notified of the inviter's deletion.

7. The method of claim 6, further providing said confirmed attendees with the option to continue meeting without the inviter for the deleted recurring dates and, if two or more confirmed attendees confirm will still attend, all confirmed attendees are notified the meeting is confirmed.

8. A method for arranging meetings between two or more users, comprising:
receiving by a server an action request from a first user over a network to take an action with respect to a recurring invitation for a proposed meeting, said recurring invitation recurring daily, any weekday, weekly or monthly;
determining whether one or more rules apply to the action request from the first user;
processing the action request if all rules determined to be applicable are satisfied; and
denying the action request if one or more rules determined to be applicable are not satisfied;
wherein:
said action request from the first user comprises one or more of the following requests: (i) pause the recurring invite; (ii) delete one or more individual dates within the range of recurring dates; and (iii) edit the invite information for one or more individual dates without modifying the invite information in the remaining invite dates.

9. The method of claim 8, wherein:
said server allows other users to view any changes made to any of the invite recurring dates.

10. The method of claim 8, wherein any changes to any recurring invites are transmitted to any users who have previously accepted the invite for the changed recurring date.

11. The method of claim 8, wherein said first user pauses the recurring invite deleting future recurring dates.

12. The method of claim 11, wherein said first user subsequently resumes the recurring invite thus continuing the recurring invites for future dates.

13. The method of claim 8, wherein said first user deletes one or more dates of the recurring invite and any confirmed attendees are notified of the inviter's deletion.

14. The method of claim 13, further providing said confirmed attendees with the option to continue meeting without the inviter for the deleted recurring dates.

15. A method for arranging meetings between two or more users, comprising:
receiving by a server an edit request from a first user over a network to edit invite information for an invitation for a proposed meeting;
determining whether one or more rules apply to the edit request from the first user;
processing the edit request if all rules determined to be applicable are satisfied; and
denying the edit request if one or more rules determined to be applicable are not satisfied;
wherein:
said edit request comprises a request to edit a portion of the invite information without opening, reviewing or loading the entire invite information or entire invite edit page.

16. The method of claim 15, wherein said portion of invite information comprises (i) time, (ii) date and/or (iii) location of the proposed meeting.

17. The method of claim 15, wherein said invite information includes: (i) time, (ii) date; (iii) location of the proposed meeting; and (iv) meeting description.

18. The method of claim 15, wherein said first user can selectively edit the time of said proposed meeting.

19. The method of claim 15, wherein said first user can selectively edit the location of said proposed meeting.

20. The method of claim 15, wherein said first user can selectively edit both the time and location of said proposed meeting.
